(19) United States
(12) Patent Application Publication
(10) Pub. No.: US 2018/0270452 A1
(43) Pub. Date: Sep. 20, 2018

(54) MULTI-POINT CONNECTION CONTROL APPARATUS AND METHOD FOR VIDEO CONFERENCE SERVICE

(71) Applicant: ELECTRONICS AND TELECOMMUNICATIONS RESEARCH INSTITUTE, Daejeon (KR)

(72) Inventors: Jong Bae MOON, Daejeon (KR); Jung-Hyun CHO, Daejeon (KR); Jin Ah KANG, Daejeon (KR); Hoon Ki LEE, Daejeon (KR); Jong Hyun JANG, Sejong (KR); Deockgu JEE, Daejeon (KR); Seung Han CHOI, Daejeon (KR); Mi Kyong HAN, Daejeon (KR)

(21) Appl. No.: 15/660,775

(22) Filed: Jul. 26, 2017

(30) Foreign Application Priority Data
Mar. 15, 2017 (KR) 10-2017-0032256

(51) Int. Cl. H04N 7/15; H04N 7/14; H04N 5/445

(52) U.S. Cl. CPC H04N 7/152; H04N 5/44504; H04N 7/147

(57) ABSTRACT

Disclosed is a multi-point connection control apparatus and method for a video conference service. The apparatus may include a front end processor configured to receive video streams and audio streams from user terminals of participants using the video conference service, and generate screen configuration information for providing the video conference service based on the received video streams and the received audio streams, and a back end processor configured to receive at least one of the video streams, at least one of the audio streams, and the screen configuration information from the front end processor, and generate a mixed video for the video conference service based on the received at least one of the video streams, at least one of the audio streams, and the screen configuration information.

### CROSS-REFERENCE TO RELATED APPLICATION(S)

This application claims the priority benefit of Korean Patent Application No. 10-2017-0032256 filed on Mar. 15, 2017, in the Korean Intellectual Property Office, the disclosure of which is incorporated herein by reference for all purposes.

### BACKGROUND

### 1. Field

One or more example embodiments relate to a multi-point connection control apparatus and method for a video conference service.

### 2. Description of Related Art

In a multi-point video conference service, a multi-point connection control apparatus may create a virtual conference room based on videos of participants using a video conference service. A forwarding/relaying multi-point connection control apparatus is advantageous in that it allows for expansion in a cloud system environment because this type of apparatus transmits a plurality of videos of participants as they are, and does not create and transmit a single composite video that is a combination of videos of participants. However, a forwarding/relaying method may overload a network because a number of connections that need to be maintained increases as a number of participants increases.

### SUMMARY

According to an aspect, there is provided a multi-point connection control apparatus for a video conference service including a front end processor configured to receive video streams and audio streams from user terminals of participants using the video conference service, and generate screen configuration information for providing the video conference service based on the received video streams and the received audio streams, and a back end processor configured to receive at least one of the video streams, at least one of the audio streams, and the screen configuration information from the front end processor, and generate a mixed video for the video conference service based on the received at least one of the video streams, at least one of the audio streams, and the screen configuration information.

The front end processor may be configured to generate the screen configuration information appropriate for a display of each of the user terminals.

The front end processor may be configured to generate information on a main speaker, and generate the screen configuration information based on the generated information on the main speaker.

The front end processor may be configured to generate information on a main speaker, and selectively transmit the received video streams and the received audio streams to the back end processor based on the generated information on the main speaker.

The multi-point connection control apparatus may include a plurality of back end processors connected to the front end processor.

The multi-point connection control apparatus may further include a chatroom manager configured to manage the video conference service, and a multi-point connection control manager configured to manage resources used for the video conference service and manage a connection between the front end processor and the back end processor.

According to another aspect, there is provided a multi-point connection control method performed by a front end processor including receiving video streams and audio streams from user terminals of participants using a video conference service, generating screen configuration information provided for the video conference service based on the received video streams and the received audio streams, and transmitting at least one of the video streams, at least one of the audio streams, and the screen configuration information to a back end processor.

According to an aspect, there is provided a multi-point connection control method performed by a back end processor including receiving video streams and audio streams associated with participants using a video conference service and video configuration information for the video conference service from a front end processor, and generating a mixed video for the video conference service based on the received video streams, the received audio streams, and the screen configuration information.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 illustrates a configuration of a system providing a multi-point video conference service according to an example embodiment;

FIG. 2 illustrates a configuration of a front end processor according to an example embodiment;

FIG. 3A illustrates screens provided based on screen configuration information generated based on sizes of displays of user terminals according to an example embodiment;

FIG. 3B illustrates screens provided based on screen configuration information generated based on information on main speakers according to an example embodiment;

FIG. 4 illustrates an example of selectively transmitting video streams and audio streams received based on information on a main speaker to a back end processor according to an example embodiment;

FIG. 5 illustrates a detailed configuration of a back end processor according to an example embodiment;

FIG. 6 is a flowchart illustrating a multi-point connection control method performed by a font end processor according to an example embodiment; and

FIG. 7 is a flowchart illustrating a multi-point connection control method performed by a back end processor according to an example embodiment.

### DETAILED DESCRIPTION

Particular structural or functional descriptions of example embodiments according to the concept of the present disclosure disclosed in the present disclosure are merely intended for the purpose of describing the example embodiments and the example embodiments may be implemented in various forms and should not be construed as being limited to those described in the present disclosure.

Though example embodiments according to the concept of the present disclosure may be variously modified and be several example embodiments, specific example embodiments will be shown in drawings and be explained in detail. However, the example embodiments are not meant to be limited, but it is intended that various modifications, equivalents, and alternatives are also covered within the scope of the claims.

Although terms of “first,” “second,” etc. are used to explain various components, the components are not limited to such terms. These terms are used only to distinguish one component from another component. For example, a first component may be referred to as a second component, or similarly, the second component may be referred to as the first component within the scope of the right according to the concept of the present disclosure.

When it is mentioned that one component is “connected” or “coupled” to another component, it may be understood that the one component is directly connected or coupled to another component or that still other component is interposed between the two components. Also, when it is mentioned that one component is “directly connected” or “directly coupled” to another component, it may be understood that no component is interposed therebetween. Expressions used to describe the relationship between components should be interpreted in a like fashion, for example, “between” versus “directly between,” or “adjacent to” versus “directly adjacent to.”

The terminology used herein is for the purpose of describing particular example embodiments only and is not intended to be limiting of example embodiments. As used herein, the singular forms are intended to include the plural forms as well, unless the context clearly indicates otherwise. It will be further understood that the terms “comprises” and/or “comprising,” when used in this specification, specify the presence of stated features, integers, steps, operations, elements, components or a combination thereof, but do not preclude the presence or addition of one or more other features, integers, steps, operations, elements, components, and/or groups thereof.

Unless otherwise defined, all terms including technical and scientific terms used herein have the same meaning as commonly understood by one of ordinary skill in the art to which example embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

Hereinafter, example embodiments will be described in detail with reference to the accompanying drawings. The scope of the right, however, should not be construed as limited to the example embodiments set forth herein. Regarding the reference numerals assigned to the elements in the drawings, it should be noted that the same elements will be designated by the same reference numerals.

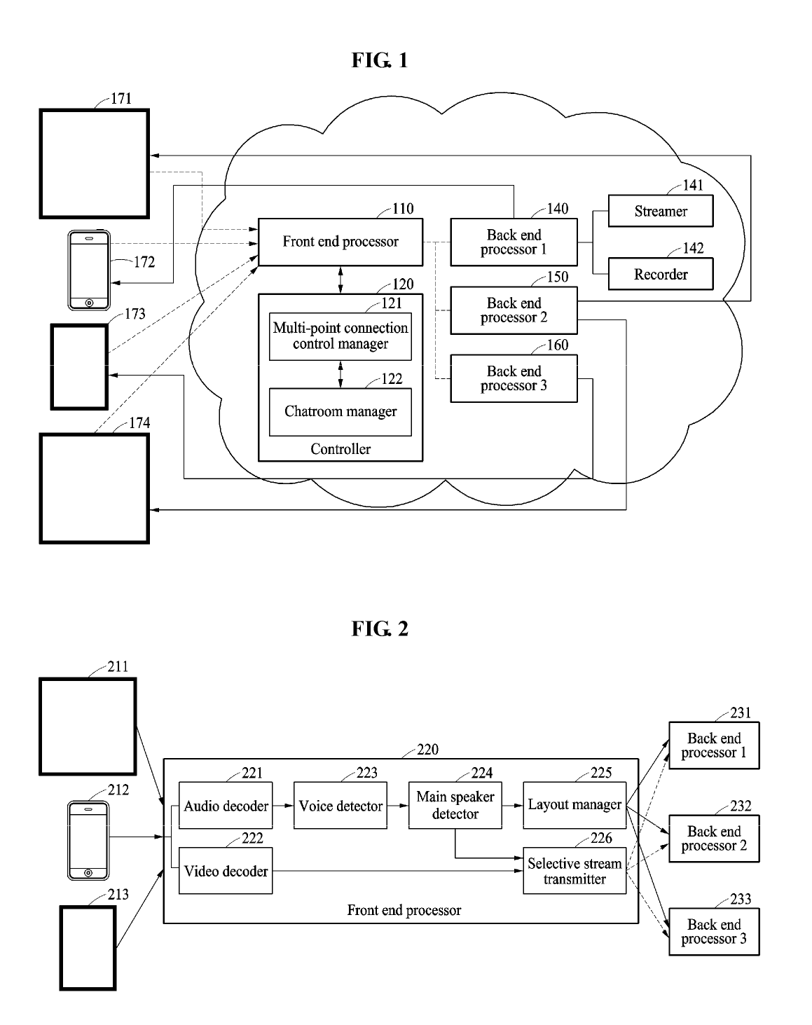

FIG. 1 illustrates a configuration of a system providing a multi-point video conference service according to an example embodiment. The system provides a telepresence service allowing multi-point video conference service users who are locally separated from each other to have a conference in a virtual space called a chatroom. The telepresence service refers to a service that provides a cognitive immersion state in which participants experience that a virtual environment is similar to a real environment in an Internet mediated environment. The system providing the multi-point video conference service may generate a conference video through stream mixing based on software and may provide the multi-point video conference service based on a cloud system environment.

A multi-point connection control apparatus used for the multi-point video conference service may manage a chatroom used for the multi-point video conference service, generate a conference video used for the multi-point video conference service, and transmit the generated conference video to the participants using the multi-point video conference service. The multi-point connection control apparatus may provide expandability of the system providing the multi-point video conference service based on the cloud system environment, and smoothly provide an immergence telepresence service in a bring your own device (BYOD) environment.

Referring to FIG. 1, a multi-point connection control system includes the multi-point connection control apparatus and user terminals 171, 172, 173, and 174.

The multi-point connection control apparatus includes a front end processor 110, a controller 120 including a multi-point connection control manager 121 and a chatroom manager 122, at least one of back end processors 140, 150, and 160, a streamer 141, and a recorder 142. At least one of the back end processors 140, 150, and 160 may be connected to the front end processor 110. FIG. 1 illustrates that the three back end processors 140, 150, and 160 are connected to the front end processor 110 for ease of description. However, the scope of example embodiment is not limited thereto.

The front end processor 110, the back end processors 140, 150, and 160, the controller 120, the streamer 141, and the recorder 142 of FIG. 1 may perform operations based on a container in the cloud system environment. Each generated container may exist in a same server or different servers in the cloud system environment.

The front end processor 110 generates screen configuration information for providing the multi-point video conference service based on video streams and audio streams received from the user terminals 171, 172, 173, and 174 of the participants. The front end processor 110 may generate the screen configuration information based on information on a main speaker and/or sizes of displays of the user terminals 171, 172, 173, and 174. The received video streams may include face videos of the participants, and the received audio streams may include voices of the participants.

The front end processor 110 transmits the received video streams and the received audio streams to the back end processors 140, 150, and 160. Because sizes of regions in which the video streams of the participants are represented are limited by sizes of the displays of the user terminals 171, 172, 173, and 174, the front end processor 110 may determine a number of participants of which video streams and audio streams are to be transmitted based on the sizes of the displays of the user terminals 171, 172, 173, and 174 connected to the back end processors 140, 150, and 160. For example, the front end processor 110 transmits video streams and audio streams except for video streams and audio streams of some participants to a back end processor connected to a user terminal including a display of which an available space for displaying the video streams of all participants is insufficient. The front end processor 110 may transmit the video streams and the audio streams except for video streams and audio streams of some participants based on a resolution of a conference video. Thus, the front end processor 110 may selectively transmit the video streams and the audio streams received from the user terminals 171, 172, 173, and 174 of the participants.

The controller 120 includes the chatroom manager 122 configured to manage the video conference service, and the multi-point connection control manager 121 configured to manage resources used for the video conference service and manage a connection between the front end processor 110 and each of the back end processors 140, 150, and 160.

The chatroom manager 122 may authenticate and manage the participants using a chatroom of the multi-point video conference service.

The chatroom manager 122 may authenticate the participants using the multi-point video conference service through an interface. The chatroom manager 122 may obtain information on the participants and information on the user terminals 171, 172, 173, and 174 used by the participants in a process of authenticating the participants. For example, the chatroom manager 122 obtains information for identifying the participants in the process of authenticating the participants and obtains information on the sizes of displays and types of user terminals 171, 172, 173, and 174 of participants. The chatroom manager 122 may transmit the obtained information on the sizes of displays and types of user terminals 171, 172, 173, and 174 of participants to the multi-point connection control manager 121, and the multi-point connection control manager 121 may perform provisioning on a virtualization instance in order to allocate initial cloud resources for creating the chatroom based on the obtained information on the sizes of displays and types of user terminals 171, 172, 173, and 174 of participants.

The chatroom manager 122 may manage the participants based on participation situations of the participants. For example, when some of the participants interrupt a conference, the chatroom manager 122 may restrict the participants or order the participants interrupting the conference to leave the chatroom.

The chatroom manager 122 may manage the chatroom of the multi-point video conference service. For example, the chatroom manager 122 creates a chatroom at a request made by an authorized participant. The authorized participant may make a request to create the chatroom through an interface of the chatroom manager 122. When the authorized participant makes the request to create the chatroom, the multi-point connection control manager 121 may be requested to allocate resources for creating the chatroom to a cloud server by the chatroom manager 122. The chatroom manager 122 may manage a recording function for storing a conference video of a chatroom and a streaming function for providing a conference video for audiences besides participants.

The multi-point connection control manager 121 may manage resources used for the video conference service. For example, the multi-point connection control manager 121 dynamically manages resources for managing a chatroom through the cloud server based on a request made by the chatroom manager 122. The multi-point connection control manager 121 may calculate resources for creating the chatroom based on a maximum number of participants using a chatroom, a number of displays of user terminals 171, 172, 173, and 174 of the participants, or types of the displays. The multi-point connection control manager 121 may perform provisioning on a virtualization instance for allocating the calculated resources. The multi-point connection control manager 121 may monitor a plurality of servers included in the cloud server, and allocate the calculated resources to a server appropriate for an allocation of the calculated resources among the monitored servers. The multi-point connection control manager 121 may return the allocated resources to the cloud server when the video conference is ended.

When a new type of a user terminal or a user terminal including a new size of display is added, the multi-point connection control manager 121 may determine information on a size of display and a type of user terminal added to determine the screen configuration information on the added user terminal. The screen configuration information may be determined in advance based on the information on the size of display and the type of user terminal. The multi-point connection control manager 121 may determine the screen configuration information appropriate for the added user terminal from the predetermined screen configuration information based on the determined information on the size of display and the type of user terminal. For example, the information on the size of display and the type of user terminal may be managed and classified into a personal computer (PC) monitor, a smartphone, and a tablet PC, and respective pieces of screen configuration information may be determined in advance. For example, when a display of an added user terminal is a PC monitor, screen configuration information of the added user terminal may be determined to be screen configuration information corresponding to a PC monitor.

The information on the size of display and the type of added user terminal may be determined by the multi-point connection control manager 121 when a user terminal of a participant and a front end processor perform a session initiation protocol (SIP)-based signaling process. In an example, the multi-point connection control manager 121 may manage the calculated resources in order to dynamically add or remove a back end processor based on a change of a size of display of user terminal. Because a single back end processor is only connectable to user terminals having displays of the same size, the multi-point connection control manager 121 may determine whether to add the back end processor based on whether to add a user terminal of a participant including a display of which a size is different from other user terminals. Based on the determination, the multi-point connection control manager 121 may manage the resources. When the back end processor is added or removed, the multi-point connection control manager 121 may allocate or return the calculated resources to the cloud server for the back end processor to be added or removed.

The multi-point connection control manager 121 may manage the generated chatroom and manage connections between the front end processor 110 and the back end processors 140, 150, and 160. For example, the multi-point connection control manager 121 manages the connections such that the generated chatroom and the front end processor 110 are connected one-to-one. The multi-point connection control manager 121 may manage the back end processors 140, 150, and 160 to be connected to the single front end processor 110 based on the size of display of user terminal.

The back end processors 140, 150, and 160 may receive at least one of video streams, at least one of audio streams, and the screen configuration information from the front end processor 110, and generate a mixed video for the multi-point video conference service based on the received at least one of the video streams, at least one of the audio streams, and the screen configuration information. The back end processors 140, 150, and 160 may perform scaling on the received video streams based on the sizes of displays of connected user terminals. The back end processors 140, 150, and 160 may generate a conference video by mixing the scaled video streams and the received audio streams based on the received screen configuration information.

The back end processors 140, 150, and 160 may be generated for each size of displays of user terminals 171, 172, 173, and 174, and the back end processors 140, 150, and 160 may be connected to the same front end processor 110. For example, the first back end processor 140 is connected to the user terminal 172, the second back end processor 150 is connected to the user terminals 171 and 174 having a same size, and the back end processor 160 is connected to the user terminal 173. Each of the back end processors 140, 150, and 160 may be connected to the front end processor 110.

The back end processors 140, 150, and 160 may transmit the mixed video to at least one of user terminals 171, 172, 173, and 174, the recorder 142, and the streamer 141. For example, when a recording function and a streaming function are set for chatroom setting, the back end processors 140, 150, and 160 transmit the mixed video to the recorder 142 and the streamer 141.

The streamer 141 may stream video data and audio data associated with the video conference service. The streamer 141 may provide a video for the video conference service for users, for example, audiences, not using the video conference service. The streamer 141 may receive the mixed video from the back end processor 140 based on the chatroom setting, and stream the received video to the audiences. When the streaming function for providing the conference video to the audiences not using the video conference service is set for the chatroom setting, the streamer 141 may receive the mixed video from the back end processor 140.

The recorder 142 may compress the mixed video by the back end processor 140, and store the compressed video. For example, the recorder 142 may store the compressed video, and provide the stored video for the participants while the multi-point video conference service is provided or after the multipoint video conference service is ended. The recorder 142 may receive the mixed video from the back end processor 140 based on the chatroom setting. For example, when the recording function for storing the conference video is set for the chatroom setting, the recorder 142 receives the mixed video from the back end processor 140.

Although the streamer 141 and the recorder 142 are connected to the first back end processor 140 only, the streamer and/or the recorder may be connected to at least one of the back end processors 140, 150, and 160.

FIG. 2 illustrates a configuration of a front end processor according to an example embodiment.

Referring to FIG. 2, a front end processor 220 includes an audio decoder 221, a video decoder 222, a voice detector 223, a main speaker detector 224, a layout manager 225, and a selective stream transmitter 226.

In an example, participants transmit video streams and audio streams to the front end processor 220 through each of user terminals 211, 212, and 213 in a bring your own device (BYOD) environment. For example, the participants and the front end processor 220 perform a session initiation protocol (SIP)-based signaling process, and transmit encoded (based on H.264 or VP8) video streams or audio streams to the front end processor 220 through an application programming interface (API), for example, a web real-time communication (WebRTC). The front end processor 220 transmits the video streams or the audio streams to back end processors 231, 232, and 233 though an internal processing process. The internal processing process is described in detail below.

The front end processor 220 may decode the received audio streams using the audio decoder 221 and decode the received video streams using the video decoder 222. The voice detector 223 may receive the decoded audio streams and detect voices of the participants from the received audio streams through voice activity detection (VAD). The main speaker detector 224 may generate information on a main speaker based on main speaker detection (MSD) through the detected voices of the participants. Speech frequency rankings of the participants may be determined based on the generated information on the main speaker. For example, the main speaker detector 224 cyclically detects a main speaker, and the speech frequency rankings of the participants are determined based on a frequency of detecting the main speaker. Information on the determined speech frequency rankings of the participants may be used for the selective stream transmitter 226 to determine which video streams and audio streams of participants to be transmitted. The information on the determined speech frequency rankings of the participants may be used as screen configuration information by a back end processor.

The layout manager 225 generates the screen configuration information appropriate for each display of the user terminals 211, 212, and 213, and transmits the generated screen configuration information to the back end processors 231, 232, and 233. For example, the screen configuration information includes information on screen arrangement of video streams of participants and information on screen resolution.

The layout manager 225 generates the screen configuration information based on a size of each display of the user terminals 211, 212, and 213. For example, in a case of a user terminal having a display in which an available region for providing additional information is present, the layout manager 225 generates the screen configuration information including additional information, for example, information on positions of participants. Also, the screen configuration information associated with adjustment of a space between the video streams of the participants based on the size of the display of user terminal.

The layout manager 225 may generate the screen configuration information based on the generated information on the main speaker. For example, the layout manager 225 may generate the screen configuration information that allows a video of a participant corresponding to the determined main speaker to be displayed in a region larger than other regions of videos of participants in an entire screen region, and allows a video stream of a participant corresponding to the main speaker to be displayed in a center of an entire screen.

The selective stream transmitter 226 generates the information of the main speaker and selectively transmits the video streams and the audio streams to the back end processors 231, 232, and 233 based on the generated information on the main speaker. For example, the selective stream transmitter 226 obtains speech frequencies based on the information on the main speaker, and determines speech frequency rankings of the participants based on the obtained speech frequencies. The selective stream transmitter 226 transmits the selectively decoded video streams and audio streams to the back end processors 231, 232, and 233 based on the determined speech frequency rankings. For example, because sizes of regions in which the video streams of the participants are displayed are limited by sizes of the displays of the user terminals 211, 212, and 213, the selective stream transmitter 226 determines a number of participants of which video streams and audio streams are to be transmitted based on the sizes of displays of the user terminals 211, 212, and 213. The selective stream transmitter 226 may priorly transmit the video streams and the audio streams of the participants of which the speech frequency rankings are relatively high based on the determined number of the participants.

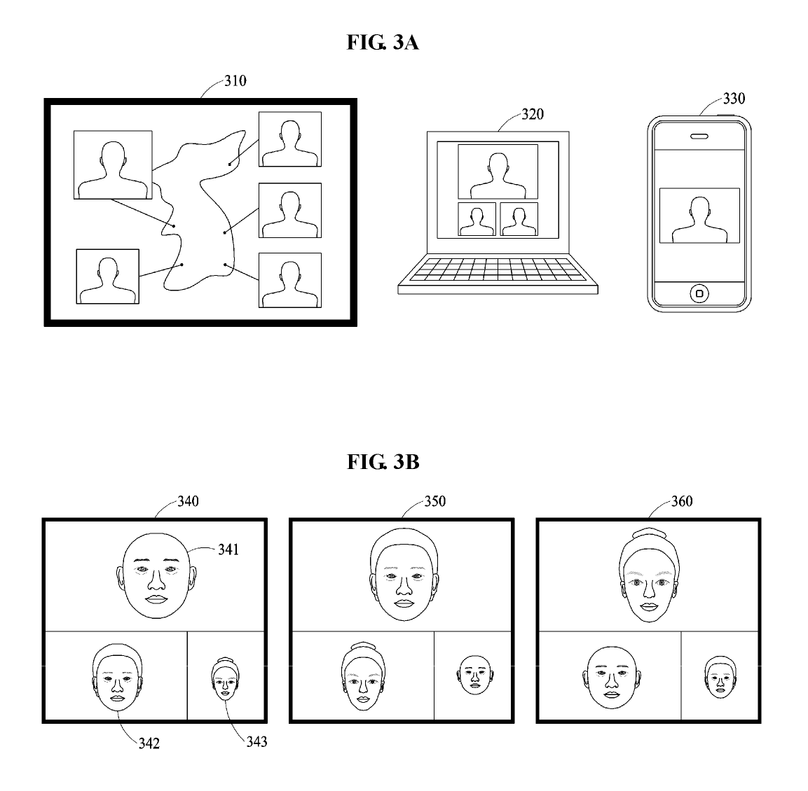

FIG. 3A illustrates screens provided based on screen configuration information generated based on sizes of displays of user terminals according to an example embodiment.

Referring to FIG. 3A, a screen of a user terminal 310 including a region representing additional information may provide video streams of participants and information on positions of the participants. For example, the screen of the user terminal 310 may be provided with the video streams of the participants and a map representing the positions of participants.

In an example, based on sizes of displays of user terminals, a screen of each of the user terminals may include regions representing video streams of different number of participants. For example, the screen of the user terminal 310 includes regions representing video streams of five participants, a screen of a user terminal 320 includes regions representing video streams of three participants, and a screen of a user terminal 330 includes a region representing a video stream of one participant.

A video stream of a participant to be displayed on a screen of a user terminal may be determined based on information on a main speaker which will be described below. For example, the screen of the user terminal 330 displays a video stream of one participant determined to be a main speaker, and the screen of the user terminal 320 displays a video stream of one participant determined to be a main speaker in addition to video streams of two participants determined in a descending order of speech frequency.

FIG. 3B illustrates screens provided based on screen configuration information generated based on information on main speakers according to an example embodiment.

Referring to FIG. 3B, each of screens 340, 350, and 360 is divided into three regions of different sizes. As determined speech frequency rankings increase, a video stream of a participant may be represented in a region of a large size. For example, the screen 340 shows a representation of a first participant 341 who is first in the speech frequency rankings, a second participant 342 who is second in the speech frequency rankings, and a third participant 343 who is third in the speech frequency rankings. A video stream of the first participant 341 is represented in a largest region, a video stream of the second participant 342 is represented in a second largest region, and a video stream of the third participant 343 is represented in a smallest region. The screen 350 shows a representation of the second participant 342 who is first in the speech frequency rankings, the third participant 343 who is second in the speech frequency rankings, and the first participant 341 who is third in the speech frequency rankings. The screen 360 shows a representation of the third participant 343 who is first in the speech frequency rankings, the first participation 341 who is second in the speech frequency rankings, and the second participant 342 who is third in the speech frequency rankings.

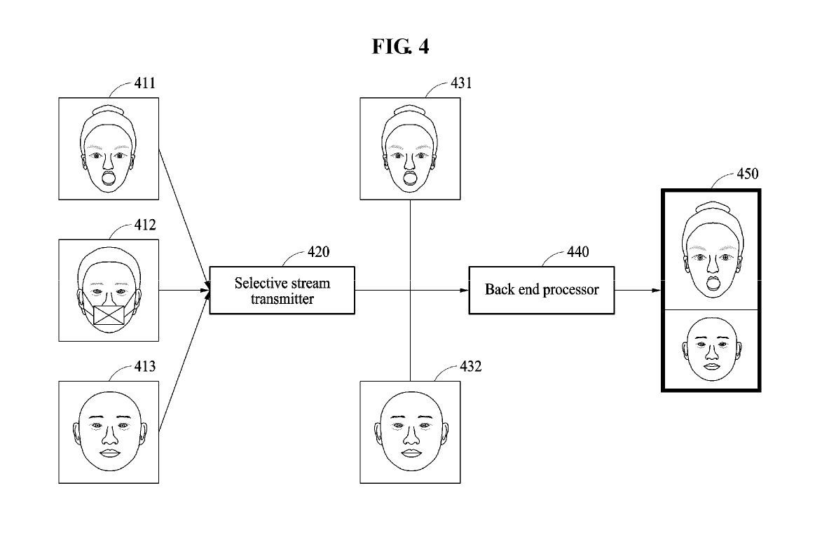

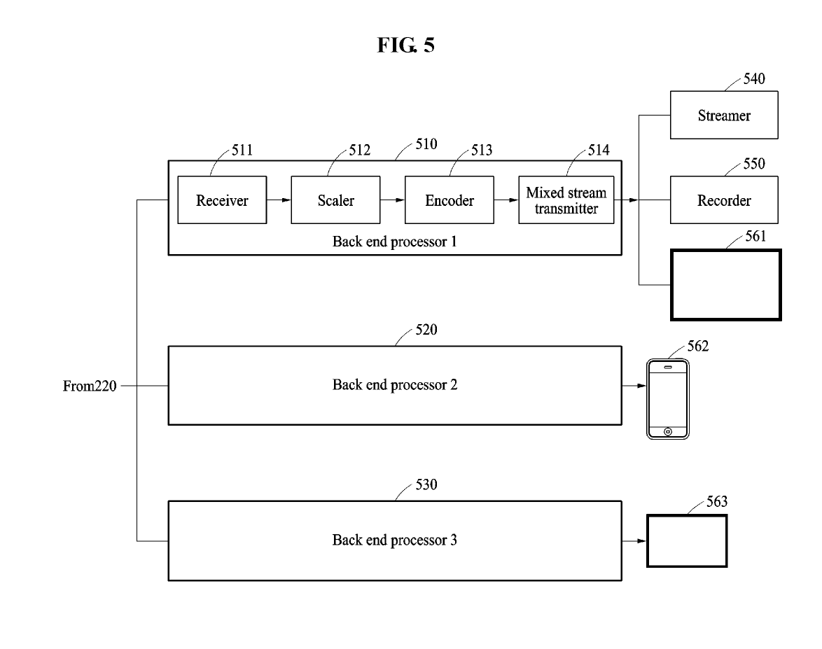

FIG. 4 illustrates an example of selectively transmitting video streams and audio streams received based on information on a main speaker to a back end processor according to an example embodiment.

Referring to FIG. 4, a selective stream transmitter 420 determines speech frequency rankings of participants through speech frequencies obtained based on generated information on a main speaker. For example, a participant 411 is determined to be a first participant as a main speaker. Although a participant 413 is not currently speaking, the participant 413 is determined to be a second participant because the participant 413 regularly speaks. A participant 412 is determined to be a third participant because the participant 412 does not speak. The selective stream transmitter 420 may determine a number of participants of which video streams and audio streams are to be transmitted based on a size of a display of the user terminal 450, and priorly transmit a video stream and audio stream of a participant of which the speech frequency rankings are highest to a back end processor. For example, when the user terminal 450 includes regions in which video streams of two participants are displayed on a screen, the selective stream transmitter 420 may transmit, to a back end processor 440, video streams and audio streams 431 and 432 of the participants 411 and 413 who are the first and second participants.

FIG. 5 illustrates a detailed configuration of a back end processor according to an example embodiment.

Referring to FIG. 5, a back end processor 510 includes a receiver 511, a scaler 512, an encoder 513, and a mixed stream transmitter 514.

In an example, back end processors 510, 520, and 530 are connected to user terminals 561, 562, and 563, respectively. The user terminals 561, 562, and 563 may include displays of different sizes, the different back end processors 510, 520, and 530 may be connected to the user terminals 561, 562, and 563 of different sizes, respectively. For example, the first back end processor 510 is connected to the user terminal 561, but is not connected to other user terminals 562 and 563 of which display sizes are different. The back end processor 510 may be simultaneously connected to other user terminals of which display sizes are identical to the display of the user terminal 561.

In an example, the back end processor 510 is connected to a streamer 540 and a recorder 550. Streamers and recorders connected to the back end processors 520 and 530 are omitted in FIG. 5 for ease of description. The back end processor 510 receives the video streams and audio streams from the front end processor 220 via the receiver 511.

The scaler 512 may adjust the received video streams based on a display environment of the user terminal 561 connected to the back end processor 510. For example, a scaler included in each back end processor performs scaling on the video streams received at different ratios based on a connected user terminal. The scaler 512 may adjust a resolution of a video mixed based on a display environment or a network environment of the user terminal 561. For example, the scaler 512 adjusts a resolution of a video based on a size or a type of a display, and reduces the resolution of the video when the network environment is insufficient.

The encoder 513 may encode the scaled video streams and audio streams and perform mixing. The encoder 513 may generate a conference video in which the video streams and audio streams of the participants are combined through mixing of the video streams and audio streams.

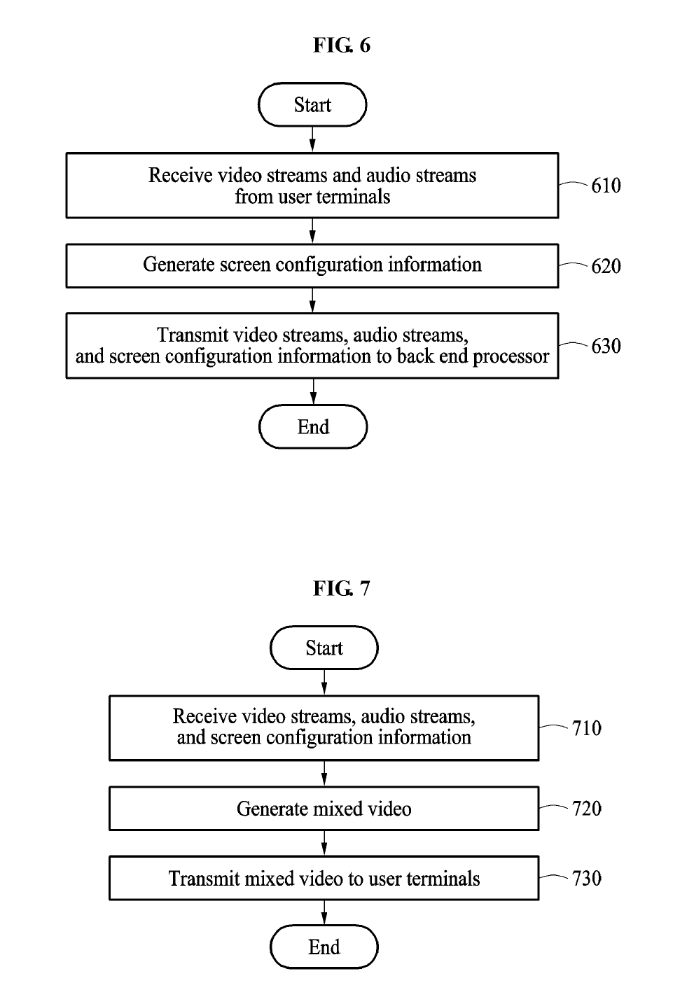

FIG. 6 is a flowchart illustrating a multi-point connection control method performed by a font end processor according to an example embodiment.

Referring to FIG. 6, in operation 610, a multi-point connection control apparatus receives video streams and audio streams from user terminals of participants. The received video streams may include face videos of the participants, and the received audio streams may include voices of the participants.

In operation 620, the multi-point connection control apparatus generates screen configuration information provided for a multi-point video conference service based on the received video streams and the received audio streams. The screen configuration information may be appropriate for each display of the user terminals. For example, the screen configuration information includes configuration information on a screen in which regions are provided differently depending on the sizes of the displays of user terminals and/or configuration information associated with additional information, for example, information on a position of user. The screen configuration information may be generated based on information on a main speaker generated by the front end processor. For example, the screen configuration information is determined to display a video of a participant corresponding to a main speaker in a relatively large region in an entire screen region, or display the video of the participant corresponding to the main speaker in a center of the screen.

In operation 630, the multi-point connection control apparatus transmits, to a back end processor, at least one of video streams, at least one of audio streams, and the screen configuration information. The video streams and audio streams may be selectively transmitted to the back end processor based on the information on the main speaker generated by the front end processor. For example, the multi-point connection control processor determines a number of participants of which video streams and audio streams are to be transmitted based on sizes of displays of user terminals. To transmit the video streams and audio streams of the determined number of participants, the multi-point connection control apparatus may determine speech frequency rankings based on the information on the main speaker, and priorly transmit a video of a participant of which the speech frequency rankings are relatively high.

FIG. 7 is a flowchart illustrating a multi-point connection control method performed by a back end processor according to an example embodiment.

Referring to FIG. 7, in operation 710, a multi-point connection control apparatus receives screen configuration information provided for a multi-point video conference service and video streams and audio streams of participants using the multi-point video conference service.

In operation 720, the multi-point connection control apparatus generates a mixed video for the multi-point video reference service based on the received video streams, the received audio streams, and the screen configuration information. The multi-point connection control apparatus may adjust a size or a resolution of the mixed video based on a display environment or a network environment of each of terminals of the participants. For example, the multi-point connection control apparatus performs scaling on the mixed video to be appropriate for sizes of displays of terminals of the participants. For example, the multi-point connection control apparatus adjusts a size (resolution) of a video based on an environment of a terminal of each participant. Also, the multi-point connection control apparatus may adjust the size of the mixed video based on the network environment. For example, when a network condition is unfavorable, the multi-point connection control apparatus reduces data volume of the video by decreasing the resolution of the mixed video.

In operation 730, the multi-point connection control apparatus transmits the mixed video to at least one of a recorder, a streamer, and the user terminals of the participants connected to a back end processor. The recorder may compress and store the mixed video, and the streamer may stream a video of the video conference service.

The components described in the exemplary embodiments of the present invention may be achieved by hardware components including at least one Digital Signal Processor (DSP), a processor, a controller, an Application Specific Integrated Circuit (ASIC), a programmable logic element such as a Field Programmable Gate Array (FPGA), other electronic devices, and combinations thereof. At least some of the functions or the processes described in the exemplary embodiments of the present invention may be achieved by software, and the software may be recorded on a recording medium. The components, the functions, and the processes described in the exemplary embodiments of the present invention may be achieved by a combination of hardware and software.

The processing device described herein may be implemented using hardware components, software components, and/or a combination thereof. For example, the processing device and the component described herein may be implemented using one or more general-purpose or special purpose computers, such as, for example, a processor, a controller and an arithmetic logic unit (ALU), a digital signal processor, a microcomputer, a field programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will be appreciated that a processing device may include multiple processing elements and/or multiple types of processing elements. For example, a processing device may include multiple processors or a processor and a controller. In addition, different processing configurations are possible, such as parallel processors.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

A number of example embodiments have been described above. Nevertheless, it should be understood that various modifications may be made to these example embodiments. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

1. A multi-point connection control apparatus for a video conference service, the apparatus comprising:
a front end processor configured to generate screen configuration information based on video streams and audio streams received from user terminals of participants using the video conference service; and
at least one back end processor configured to generate a mixed video based on the video streams, the audio streams, and the screen configuration information received from the front end processor,
wherein the back end processor is provided for each type of the user terminals.

2. The apparatus of claim 1, wherein the back end processor is provided for each display size of the user terminals.

3. The apparatus of claim 1, wherein the back end processor is provided for each display size of the user terminals through resource allocation to a cloud server.

4. The apparatus of claim 1, wherein one back end processor is configured to transmit the mixed image to one or more user terminals having the same display size.

5. The apparatus of claim 3, wherein when one or more user terminals having the same display size are disconnected from the video conference service, a resource allocated to a back end processor corresponding to the one or more user terminals is returned to the cloud server.

6. The apparatus of claim 1, wherein the front end processor is configured to generate screen configuration information corresponding to a display size of each of the user terminals.

7. The apparatus of claim 1, wherein the multi-point connection control apparatus includes a plurality of back end processors connected to the front end processor.

8. The apparatus of claim 1, further comprising:
a chatroom manager configured to manage the video conference service; and
a multi-point connection control manager configured to manage resources used for the video conference service and manage a connection between the front end processor and the back end processor.

9. The apparatus of claim 1, further comprising:
a recorder configured to compress the mixed video and store the compressed video; and
a streamer configured to stream a video of the video conference service.

10. A multi-point connection control method performed by a front end processor, the method comprising:
receiving video streams and audio streams from user terminals of participants using a video conference service;
generating screen configuration information for each display size of the user terminals based on the received video streams and the received audio streams; and
transmitting the video streams, the audio streams, and the screen configuration information to a back end processor provided for each display size of the user terminals.

11. A multi-point connection control method performed by a back end processor, the method comprising:
receiving video streams and audio streams associated with participants using a video conference service and screen configuration information from a front end processor; and
generating a mixed video for one or more participant terminals having the same display size based on the received video streams, the received audio streams, and the screen configuration information; and
transmitting the mixed video to the one or more participant terminals having the same display size.

12. The method of claim 11, wherein the generating of the mixed video comprises adjusting a resolution or a size of the mixed video based on a display environment or a network environment of each of the participant terminals.

13-16. (canceled)
